(19) United States
(12) Patent Application Publication
(10) Pub. No.: US 2018/0129793 A1
(43) Pub. Date: May 10, 2018

(54) PRECOMPILE AND ENCRYPT INDUSTRIAL INTELLECTUAL PROPERTY

(71) Applicant: Rockwell Automation Technologies, Inc., Mayfield Heights, OH (US)

(72) Inventors: Dylan A. Ulis, Wadsworth, OH (US); Kevin A. Fonner, North Canton, OH (US); Derek P. Miller, Lyndhurst, OH (US); James J. Kay, Chardon, OH (US); Douglas W. Reid, Mentor, OH (US); Jack M. Visoky, Willoughby, OH (US); Richard M. Cherney, Seven Hills, OH (US); John E. Belcher, Euclid, OH (US); Taryl J. Jasper, South Euclid, OH (US)

(21) Appl. No.: 15/383,908

(22) Filed: Dec. 19, 2016

Related U.S. Application Data
(60) Provisional application No. 62/418,575, filed on Nov. 7, 2016.

(51) Int. Cl. G06F 21/12; G06F 9/44

(52) U.S. Cl. CPC G06F 21/12; G06Q 2220/165; G06F 8/70

(57) ABSTRACT

An industrial precompile and encrypt system facilitates secure distribution of a digital industrial asset to a target device in an industrial automation environment while permitting common, expected user workflows such as interfacing with the asset; replacing failed target devices; verifying and validating the asset and its usage; securely troubleshooting the asset, editing the asset, or replacing the asset in a running system.

### CROSS-REFERENCE TO RELATED APPLICATIONS

This application claims priority to U.S. Provisional Application Ser. No. 62/418,575, filed on Nov. 7, 2016, and entitled “PRECOMPILE AND ENCRYPT INDUSTRIAL INTELLECTUAL PROPERTY,” the entirety of which is incorporated herein by reference.

### BACKGROUND

The subject matter disclosed herein relates generally to distribution of digital intellectual property

### BRIEF DESCRIPTION

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

In one or more embodiments, a system for protecting a digital industrial asset is provided, comprising an interface analysis component configured to determine one or more interfaces of the digital industrial asset based on a determination of one or more elements of an industrial system referenced by source code of the digital industrial asset, and to generate interface metadata describing the one or more interfaces; and a source code protection component configured to encrypt the source code using key data associated with an authorized user to yield protected source code, and to generate a protected asset comprising the protected source code and the interface metadata.

Also, in one or more embodiments, a method for creating a deliverable industrial software asset is provided, comprising determining, by a system comprising a processor, one or more interfaces of the industrial software asset, the interfaces comprising references, defined in source code of the industrial software asset, to one or more elements of an industrial system; generating, by the system, interface metadata describing the one or more interfaces; encrypting, by the system, the source code using key data associated with an authorized user to yield protected source code; and generating, by the system, a protected asset comprising the protected source code and the interface metadata.

Also, according to one or more embodiments, a non-transitory computer-readable medium is provided having stored thereon instructions that, in response to execution, cause a system to perform operations, the operations comprising determining one or more interfaces of a digital industrial asset, the interfaces comprising references, defined in source code of the digital industrial asset, to one or more elements of an industrial system; generating interface metadata describing the one or more interfaces; encrypting the source code using key data associated with an authorized user to yield encrypted source code; and generating a protected asset comprising the encrypted source code and the interface metadata.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example industrial control environment.

FIG. 2 is a block diagram of an example precompile and encrypt system.

FIG. 3 is a block diagram illustrating generation of interface metadata by and interface analysis component.

FIG. 4 is a block diagram illustrating generation of interface mapping metadata by an interface mapping component.

FIG. 5 is a block diagram illustrating generation of compilation context metadata by a compilation context component.

FIG. 6 is a block diagram illustrating generation of protected source code by a source code protection component.

FIG. 7 is a block diagram illustrating generation of protected executable code by an executable code protection component.

FIG. 8 is a flowchart of an example methodology for protecting an industrial software asset.

FIG. 9 is an example computing environment.

FIG. 10 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

Industrial controllers and their associated I/O devices are central to the operation of modern automation systems. These controllers interact with field devices on the plant floor to control automated processes relating to such objectives as product manufacture, material handling, batch processing, supervisory control, and other such applications. Industrial controllers store and execute user-defined control programs to effect decision-making in connection with the controlled process. Such programs can include, but are not limited to, ladder logic, sequential function charts, function block diagrams, structured text, or other such platforms.

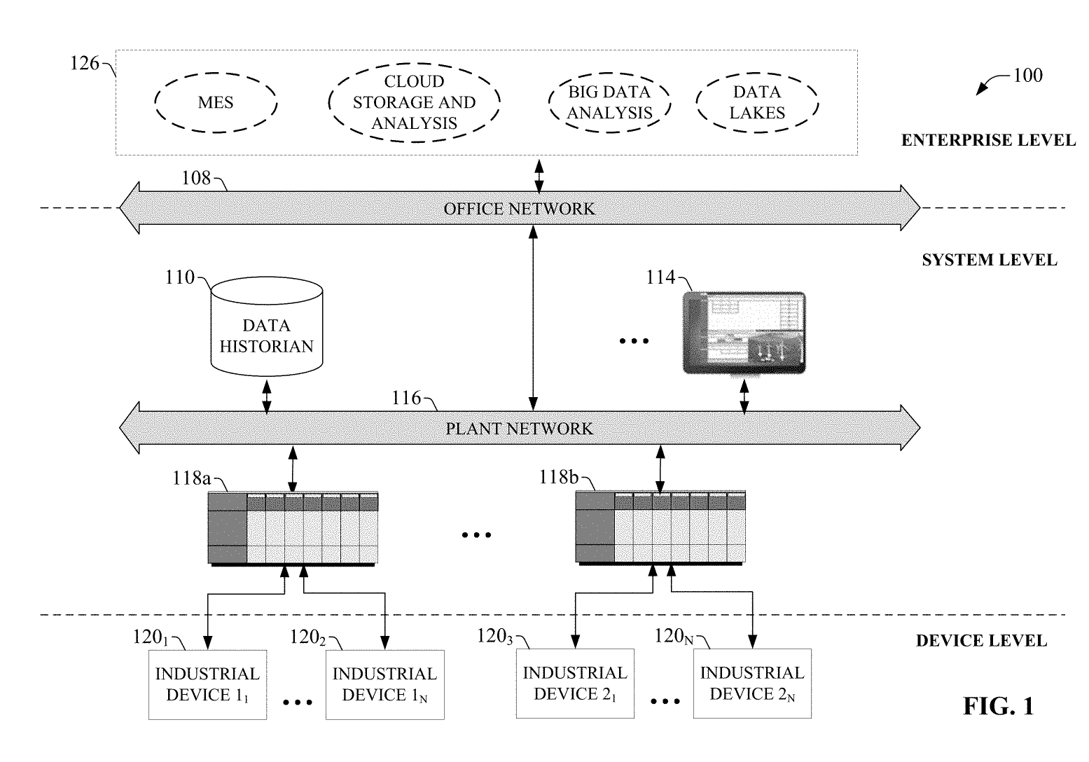

FIG. 1 is a block diagram of an example industrial control environment 100. In this example, a number of industrial controllers 118 are deployed throughout an industrial plant environment to monitor and control respective industrial systems or processes relating to product manufacture, machining, motion control, batch processing, material handling, or other such industrial functions. Industrial controllers 118 typically execute respective control programs to facilitate monitoring and control of industrial devices 120 making up the controlled industrial systems. One or more industrial controllers 118 may also comprise a soft controller executed on a personal computer or other hardware platform, or on a cloud platform. Some hybrid devices may also combine controller functionality with other functions (e.g., visualization). The control programs executed by industrial controllers 118 can comprise any conceivable type of code used to process input signals read from the industrial devices 120 and to control output signals generated by the industrial controllers, including but not limited to ladder logic, sequential function charts, function block diagrams, or structured text.

Industrial devices 120 may include both input devices that provide data relating to the controlled industrial systems to the industrial controllers 118, and output devices that respond to control signals generated by the industrial controllers 118 to control aspects of the industrial systems. Example input devices can include telemetry devices (e.g., temperature sensors, flow meters, level sensors, pressure sensors, etc.), manual operator control devices (e.g., push buttons, selector switches, etc.), safety monitoring devices (e.g., safety mats, safety pull cords, light curtains, etc.), and other such devices. Output devices may include motor drives, pneumatic actuators, signaling devices, robot control inputs, valves, and the like.

Industrial controllers 118 may communicatively interface with industrial devices 120 over hardwired or networked connections. For example, industrial controllers 118 can be equipped with native hardwired inputs and outputs that communicate with the industrial devices 120 to effect control of the devices. The native controller I/O can include digital I/O that transmits and receives discrete voltage signals to and from the field devices, or analog I/O that transmits and receives analog voltage or current signals to and from the devices. The controller I/O can communicate with a controller's processor over a backplane such that the digital and analog signals can be read into and controlled by the control programs. Industrial controllers 118 can also communicate with industrial devices 120 over a network using, for example, a communication module or an integrated networking port. Exemplary networks can include the Internet, intranets, Ethernet, DeviceNet, ControlNet, Data Highway and Data Highway Plus (DH/DH+), Remote I/O, Fieldbus, Modbus, Profibus, wireless networks, serial protocols, and the like. The industrial controllers 118 can also store persisted data values that can be referenced by the control program and used for control decisions, including but not limited to measured or calculated values representing operational states of a controlled machine or process (e.g., tank levels, positions, alarms, etc.) or captured time series data that is collected during operation of the automation system (e.g., status information for multiple points in time, diagnostic occurrences, etc.). Similarly, some intelligent devices—including but not limited to motor drives, instruments, or condition monitoring modules—may store data values that are used for control and/or to visualize states of operation. Such devices may also capture time-series data or events on a log for later retrieval and viewing.

Industrial automation systems often include one or more human-machine interfaces (HMIs) 114 that allow plant personnel to view telemetry and status data associated with the automation systems, and to control some aspects of system operation. HMIs 114 may communicate with one or more of the industrial controllers 118 over a plant network 116, and exchange data with the industrial controllers to facilitate visualization of information relating to the controlled industrial processes on one or more pre-developed operator interface screens. HMIs 114 can also be configured to allow operators to submit data to specified data tags or memory addresses of the industrial controllers 118, thereby providing a means for operators to issue commands to the controlled systems (e.g., cycle start commands, device actuation commands, etc.), to modify setpoint values, etc. HMIs 114 can generate one or more display screens through which the operator interacts with the industrial controllers 118, and thereby with the controlled processes and/or systems. Example display screens can visualize present states of industrial systems or their associated devices using graphical representations of the processes that display metered or calculated values, employ color or position animations based on state, render alarm notifications, or employ other such techniques for presenting relevant data to the operator. Data presented in this manner is read from industrial controllers 118 by HMIs 114 and presented on one or more of the display screens according to display formats chosen by the HMI developer. HMIs may comprise fixed location or mobile devices with either user-installed or pre-installed operating systems, and either user-installed or pre-installed graphical application software.

Some industrial environments may also include other systems or devices relating to specific aspects of the controlled industrial systems. These may include, for example, a data historian 110 that aggregates and stores production information collected from the industrial controllers 118 or other data sources. Other systems may include inventory tracking system, work order management systems, repositories for machine or process drawings and documentation, vendor product documentation storage, vendor knowledgebases, internal knowledgebases, work scheduling applications, or other such systems, some or all of which may reside on the plant network 116 or an office network 108 of the industrial environment.

Other higher-level systems 126 may carry out functions that are less directly related to control of the industrial automation systems on the plant floor, but rather are directed to long term planning, high-level supervisory control, reporting, or other such functions. These systems may reside on the office network 108 or at an external location relative to the plant facility, and may include, but are not limited to, cloud storage and analysis systems, big data analysis systems, manufacturing execution systems, data lakes, reporting systems, etc.

Many devices deployed in an industrial automation environment and associated office environment—e.g. devices described in connection with FIG. 1 as well as other devices not shown in FIG. 1—execute proprietary software (e.g., executable code) or other digital assets to carry out some or all of their functionality. Many industrial system developers, such as original equipment manufacturers (OEMs), rely on their software or digital intellectual property to maintain their competitive advantage. In many instances, it is difficult to prevent competitors from reverse engineering and copying the mechanical design of a machine designed and built by an OEM or other equipment manufacturer, especially in areas where the intellectual property (IP) protection is weak. Consequently, the controls surrounding software IP are often the last defense against IP theft.

Reports of customer incidents involving theft of software IP, as well as the results of penetration tests performed by security vendors, have confirmed that software IP theft remains a pervasive problem. As such, there is a need for a method of distributing software or digital IP (e.g., source and/or executable code created by OEMs or other industrial asset vendors) without the need for end user computers to access that IP for any reason (e.g., for the purposes of compilation, verification, interfacing with unprotected code, etc.).

The present disclosure is directed to a system and method for securely distributing software IP to a target device in an industrial automation environment while allowing common, expected user workflows such as interfacing with the software; replacing failed target devices that execute the software; verifying and validating the software and its usage; securely troubleshooting, editing, or replacing the software in a running system; etc.

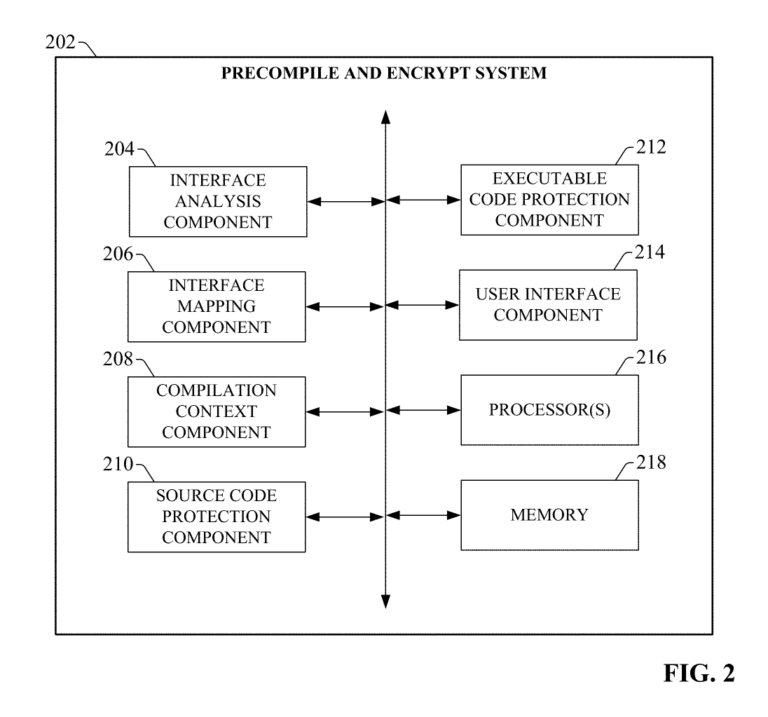

FIG. 2 is a block diagram of an example precompile and encrypt system 202 according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Precompile and encrypt system 202 can include an interface analysis component 204, an interface mapping component 206, a compilation context component 208, a source code protection component 210, an executable code protection component 212, a user interface component 214, one or more processors 216, and memory 218. In various embodiments, one or more of the interface analysis component 204, interface mapping component 206, compilation context component 208, source code protection component 210, executable code protection component 212, user interface component 214, the one or more processors 216, and memory 218 can be electrically and/or communicatively coupled to one another to perform one or more of the functions of the precompile and encrypt system 202. In some embodiments, components 204, 206, 208, 210, 212, and 214 can comprise software instructions stored on memory 218 and executed by processor(s) 216. Precompile and encrypt system 202 may also interact with other hardware and/or software components not depicted in FIG. 2. For example, processor(s) 216 may interact with one or more external user interface devices, such as a keyboard, a mouse, a display monitor, a touchscreen, or other such interface devices.

The one or more processors 216 can perform one or more of the functions described herein with reference to the systems and/or methods disclosed. Memory 218 can be a computer-readable storage medium storing computer-executable instructions and/or information for performing the functions described herein with reference to the systems and/or methods disclosed.

Interface analysis component 204 can be configured to analyze industrial IP to identify interfaces to other software applications or devices defined by the IP. Such interfaces can include, for example, data tags of other devices or software applications, modules, data types, instructions, or other such interfaces. Analysis component 204 documents the identified interfaces as interface metadata.

Interface mapping component 206 can be configured to create and document a layer of indirection for all components present in the IP's interface as interface mapping metadata. Compilation context component 208 can be configured to capture and store details about the compilation context of the industrial IP as compilation context metadata.

Source code protection component 210 can be configured to encrypt the software IP in source code form using one or more keys derived from material that only authorized users possess (e.g., passphrases, biometric data, hardware tokens, etc.). Executable code protection component 212 can be configured to encrypt the software IP in executable code form using a combination of one or more keys derived from material that only authorized users and the target execution device possess and the public key corresponding to a private key controlled by devices of the same type as the execution device.

User interface component 214 can be configured to receive user input and to render output to the user in any suitable format (e.g., visual, audio, tactile, etc.). For example, the user interface component 214 can be configured to receive user key data (e.g., biometric data, passphrases, etc.) used to cryptographically protect the software IP.

The one or more processors 216 can perform one or more of the functions described herein with reference to the systems and/or methods disclosed. Memory 218 can be a computer-readable storage medium storing computer-executable instructions and/or information for performing the functions described herein with reference to the systems and/or methods disclosed.

In some embodiments, precompile and encrypt system 202 can be an integrated subsystem of a software development environment on which the software IP is developed. For example, in some embodiments in which the software IP to be protected is industrial control software to be executed on an industrial controller, system 202 can be a component of an industrial control program development application.

The precompile and encrypt system 202 allows for the secure distribution of software IP in an industrial automation environment in two forms:

1) Source code is stored for distribution via cryptographic means such that only authorized users, such as field service engineers associated with the owning OEM, may access the source code for troubleshooting and modification.

2) Executable code is stored for distribution via cryptographic means such that only the target execution device (or a replacement device, in the case of a device failure) can access and execute the executable code.

In addition to these two forms of IP, a variety of additional system generated metadata is produced by the system 202 and included or bundled with the software IP. This metadata includes one or more of interface metadata, interface mapping metadata, and compilation context metadata. These various types of metadata are described in more detail below.

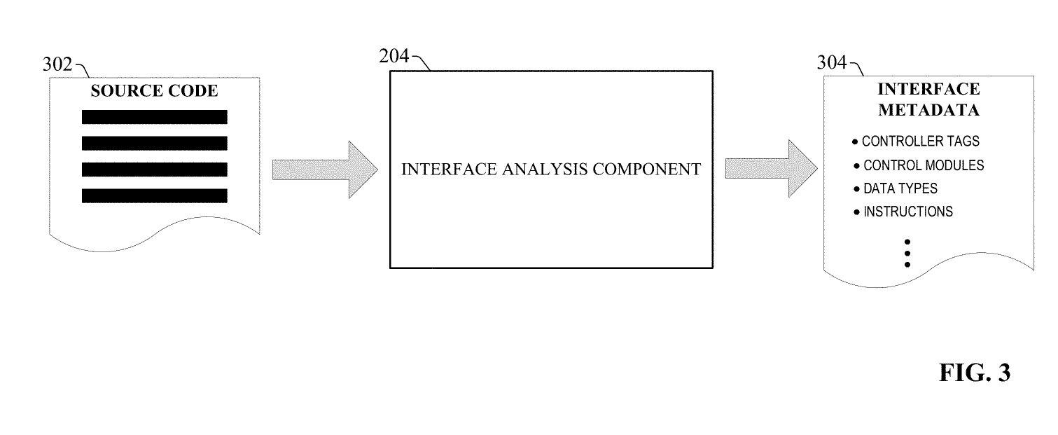

FIG. 3 is a block diagram illustrating generation of interface metadata 304 by interface analysis component 204. Interface analysis component 204 is configured to analyze source code 302 of the software IP in order to determine the interfaces of the software IP at the time of compilation. Interface analysis component 204 determines the interfaces based on the source code's usage of, or reference to, other elements of the automation system for which the IP was designed. These interfaces can include, for example, data tags of other software applications or other devices that are referenced within the source code 302 (e.g., data tags of industrial control programs or HMI applications). Interfaces can also include modules of other devices or software applications referenced by the source code 302, data types referenced by the source code 302, instructions referenced by the source code, or other such interfaces.

In an example scenario, an OEM may develop an industrial control program that is to be integrated with a customer's existing automation system in order to control a machine being built and sold to the customer by the OEM. The source code 302 of the OEM-provided industrial control program may be required to read data from, and write data to, an existing control program executing at the customer facility, either on the same industrial controller as OEM-provided control program or on a device that is remote relative to the execution environment on which the OEM-provided control program will run. To facilitate these data exchanges, the source code 302 will include references to the data tags of the end user's control program (and, if appropriate, the devices on which the tags are located); e.g., in the form of tag definitions. Interface analysis component 204 can identify these references to external data tags, as well as properties of each identified data tag, including but not limited to the tag names, the data type of each data tag, how each data tag is being used by the OEM-provided control program, etc.

Once the various interfaces defined in the source code have been identified, the interface analysis component 204 generates and stores a description of the determined interfaces as system-generated interface metadata 304. Interface metadata 304 also defines, for each interface, one or more constraints on how the interface may be modified by the end user. For example, for each data tag of an OEM-provided control program, interface analysis component 204 can identify how the data tag is being used by the program, and determine which properties of the data tag must be constrained in order to ensure proper operation of the control program. In an example scenario, the interface analysis component may determine that altering the data type of a particular data tag will cause the control program to operate improperly, or to fail to operate entirely. Accordingly, the interface analysis component 204 defines within the interface metadata 304 a constraint on the data type for that data tag. Similarly, the interface analysis component 204 may determine that a particular data tag that produces and sends data to a data tag of a remote device should not be modified to send data to a different data tag or device. Based on this determination, interface analysis component 204 defines within the interface metadata 304 a constraint on this data tag interface that prevents redirection of the data tag to a different destination device or data tag.

After the software IP has been deployed to the end user (e.g., the OEM's customer), interface metadata 304 can be used to validate that changes to the automation system made subsequently (including changes made by users without view or edit authorization) have not invalidated the usage of the protected IP as defined by the interface metadata. Specifically, the interface metadata 304 is used to enforce the constraints on the interfaces defined by the metadata. In an example scenario, the software IP represented by source code 302 may be designed to work in association with another industrial application (e.g., an industrial controller program, an HMI application, etc.). Accordingly, the software IP may include references to one or more data tags of the industrial application. After system 202 has protected the software and the software has been distributed to the end user, a data tag used or referenced by the protected software may be changed by the end user in a manner that could cause the IP to execute in an unexpected manner By documenting the data tags or other interfaces defined within the source code 302 at the time of the source code's compilation, the interface metadata 304 provides a means for the automation software to detect and/or prevent such a change to the tag. For example, after receipt of the protected software from the OEM, the end user may open the enclosed industrial control program within an industrial control program development application and attempt to modify a constrained property or attribute of one of the data tags (or other type of identified interface). Validation components included in the development application can determine whether the user's modification violates an interface constraint defined by the interface metadata 304 and, if so, prevent or override the modification. The development application may also generate and display a warning indicating that the attempted modification is prohibited in accordance with the IP protection.

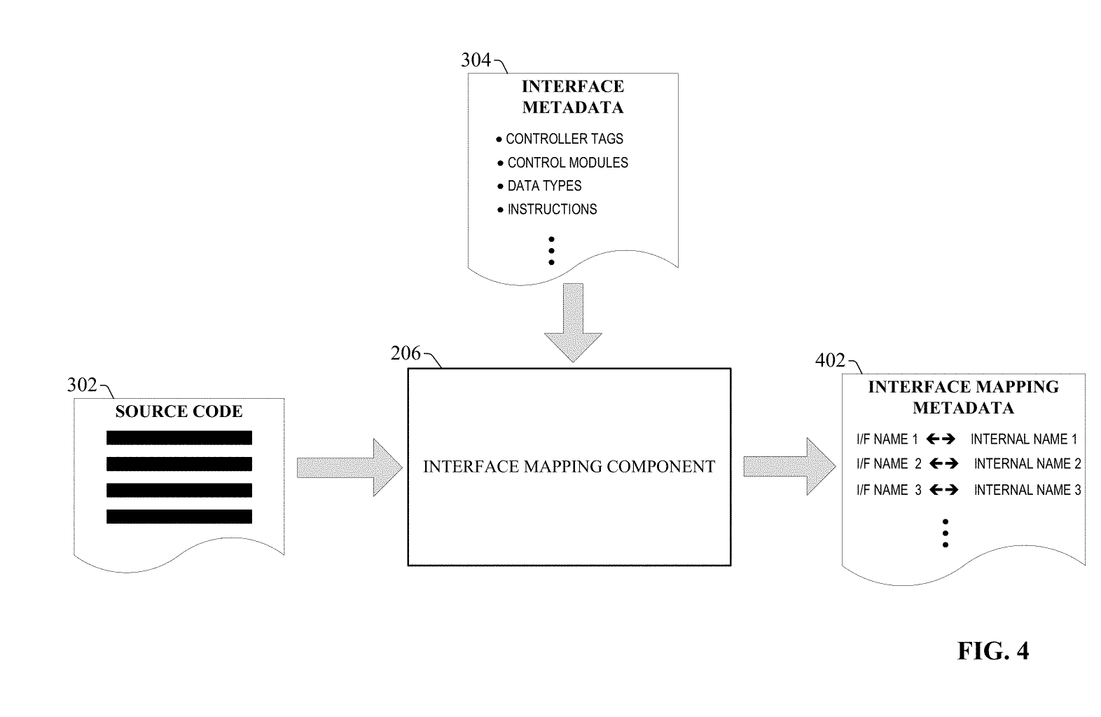

FIG. 4 is a block diagram illustrating generation of interface mapping metadata 402 by interface mapping component 206. The interface mapping component 206 can create and document a layer of indirection for all components present in the source code 302 as interface mapping metadata. This allows subsequent users of the software IP represented by the source code 302 (including users without edit or view authorization) to remap components used in the protected software without the need to access the software (in either source or executable form). This not only allows simple remapping within the context of an existing automation system, but also allows complex remapping and redistribution to additional automation systems.

Creating the layer of indirection involves associating each identified interface (e.g., data tag or other type of interface) with an internal name generated by the interface mapping component 206. When the source code 302 is compiled to yield executable code, it is compiled against the internal name rather than the data tag name defined in the source code. After deployment of the protected source code, the end user may choose to alter one of the interfaces of the source code 302 to link the interface to a different customer-side data tag or to rename the interface. For example, a data tag of the protected software (e.g., control program) may initially be linked by reference to a particular customer-side data tag of an application running as part of the customer's existing automation system. The end user may wish to install the protected software on a second automation system elsewhere in the plant, which may use a different set of data tags or which may otherwise be programmed differently than the original automation system. In the process of installing the protected software on this new automation system, the end user may modify the source code 302 to redirect the interface of the protected software to a different data tag associated with the new system, or may rename the interface (e.g., control program data tag) in order to mitigate a conflict with a similarly named data tag of the target automation system. The user can effect these changes, for example, by modifying properties of the source code 302 in a program development application (e.g., by editing the industrial control program). After the interface modification, the modified interface (e.g., data tag) remains associated with its corresponding internal name defined by the interface mapping metadata 402. The modified interface also maintains the interface-level constraints defined by the interface metadata 304. If the source code 302 is subsequently modified and recompiled, the source code 302 is compiled against the internal name rather than the tag name, the internal name acting as a fixed layer of abstraction between the interface or tag name and the compiled code.

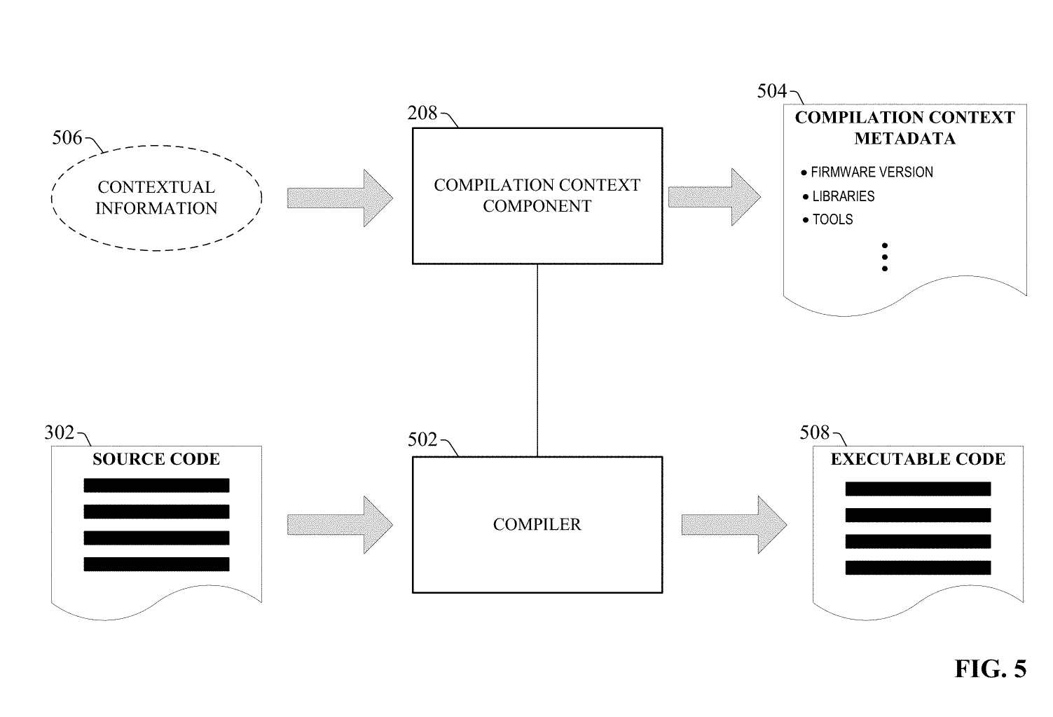

FIG. 5 is a block diagram illustrating generation of compilation context metadata 504 by compilation context component 208. Compilation context component can capture and store relevant information about the protected software's compilation context as compilation context metadata 504. For example, when the completed source code 302 is compiled on an application development system (e.g., the development system used to write or edit the source code 302), a compiler 502 of the development system generates executable code 508 based on the source code 302. This executable code 508 can be installed and executed on a target device (e.g., an industrial controller in the case of industrial control programming) As part of the compilation process, compilation context component 208 can identify hardware-specific contexts necessary for proper execution of the executable code 508, and record this information as compilation context metadata 504.

For example, executable code 508 may require access to one or more hardware-specific or firmware-specific libraries (e.g., dynamic link libraries or other such data). As such, executable code 508 may only be installed on devices having the necessary libraries. The presence of these libraries on a target device may be a function of the device type and/or the firmware installed on the device. Compilation context component 208 can identify these contexts based on analysis of the source code itself 302 and, in some embodiments, contextual information 506 about the execution platform for which the source code 302 is compiled. For example, compilation context component 208 may identify a reference within the source code 302 to one or more data items of a library or tool that is specific to firmware or device version of an industrial controller. In addition to identifying the library or tool referenced within the source code 302, the compilation context component 208 may obtain additional information about the library or tool based on contextual information 506 collected from the execution platform for which the source code 302 is being compiled. This information can include a current firmware version installed on the execution platform, identification of one or more libraries supported by the execution platform, or other such information. Based on this collected information, compilation context component 208 generates compilation context metadata 504 identifying these requisite execution contexts.

Compilation context metadata 504 allows the automation software to detect incompatibilities between the protected executable code and the target execution device that could result in unexpected execution. For example, if the end user attempts to download the executable code 508 on an industrial controller or other device that does not satisfy the execution context requirements defined by the compilation context metadata, the application used to download the executable code (e.g., an application development application) can compare the hardware specifications of the target device with the execution context requirements defined by the compilation context metadata 504 and prevent the download in response to determining that the target device does not satisfy or support the defined execution requirements. The application may also generate a warning message indicating that the executable code 508 cannot be executed properly on the target device. The warning message may also identify one or more countermeasures that would allow the user to execute the executable code 508 on the target device. For example, if an updated version of the device's firmware would include the libraries necessary for proper operation of the executable code 508, the application may generate a recommendation to install the new firmware on the target device prior to download and execution of the executable code 508.

In some embodiments, the three types of metadata described above in connection with FIGS. 3-5 can be generated as part of the source code compilation process. That is, when the software developer has completed development of the software to be protected and initiates compilation of the source code 302, system 202 can generate the interface metadata 304, interface mapping metadata 402, and compilation context metadata 504 as described above, in addition to compiling the source code 302 into executable code. In some embodiments, the generation of the metadata can be initiated as part of a separate process independent of compilation (e.g., in scenarios in which the developer wishes to distribute the source code 302 itself to end users). One or both of the source code 302 and the executable code can be bundled with the metadata, and the resulting bundled software package can then be deployed to end users.

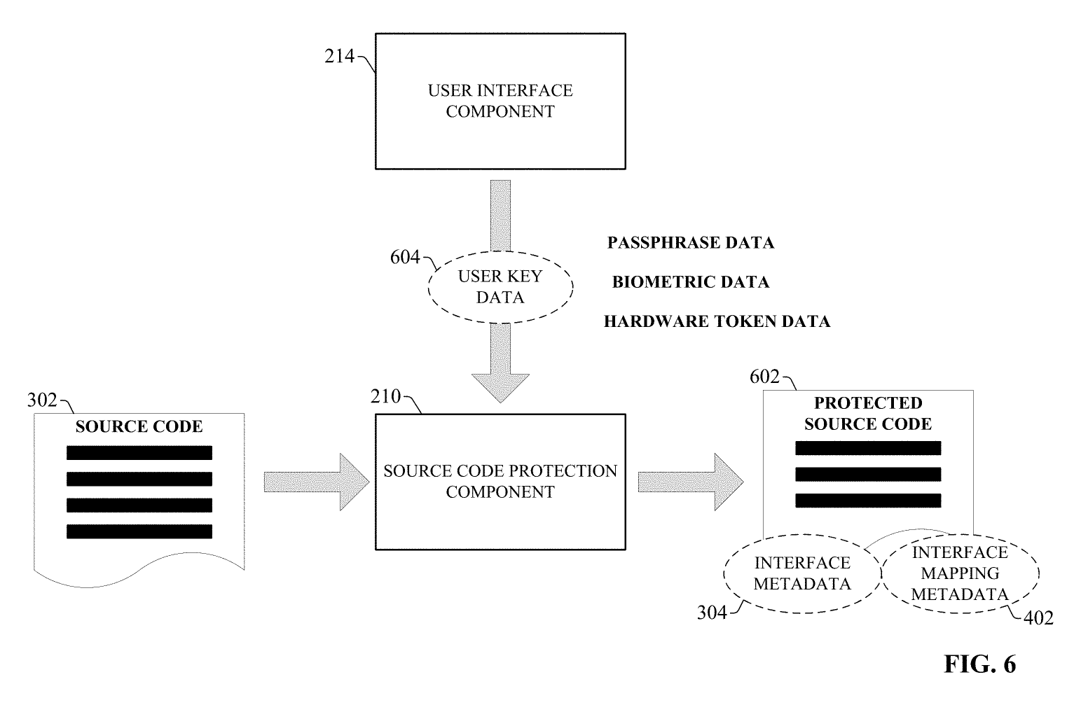

In addition to the protections offered by the metadata described above, the system 202 can also encrypt the source code 302 and/or the executable code prior to distribution. FIG. 6 is a block diagram illustrating generation of protected source code 602 by the source code protection component 210. Source code protection component 210 can encrypt software IP in source code form using user key data 604 derived from material that only authorized users possess. Example user key data 604 can include, but is not limited to, passphrase data, biometric data, data extracted from hardware tokens, or other such data. In an example scenario, the user interface component 214 may be configured to generate a display that prompts the developer for user key information (e.g., a password, biometric information, etc.). Based on the key information provided by the developer, the source code protection component 210 will encrypt the source code 302 to produce protected source code 602, which can only be viewed and edited by a user who can provide the user key data 604. For example, if a user attempts to open and view the source code using a program development application, the development application will detect that the protected source code 602 requires entry of user key data before the protected source code 602 can be rendered for viewing and editing. In response to this determination, the development application will prompt the user to provide the user key data matching the user key data 604 used to encrypt the original source code 302, and will only render the source code if the correct key data is provided. In this way, the constraints defined by the metadata cannot be modified unless a user provides the user key data 604.

The source code 302 is protected separately from executable code, which is always generated in the same protected state regardless of the user's source code authorization to allow the user, via the automation software, to execute standard workflows such as troubleshooting, modifying, and replacing protected software IP even when in an untrusted automation environment.

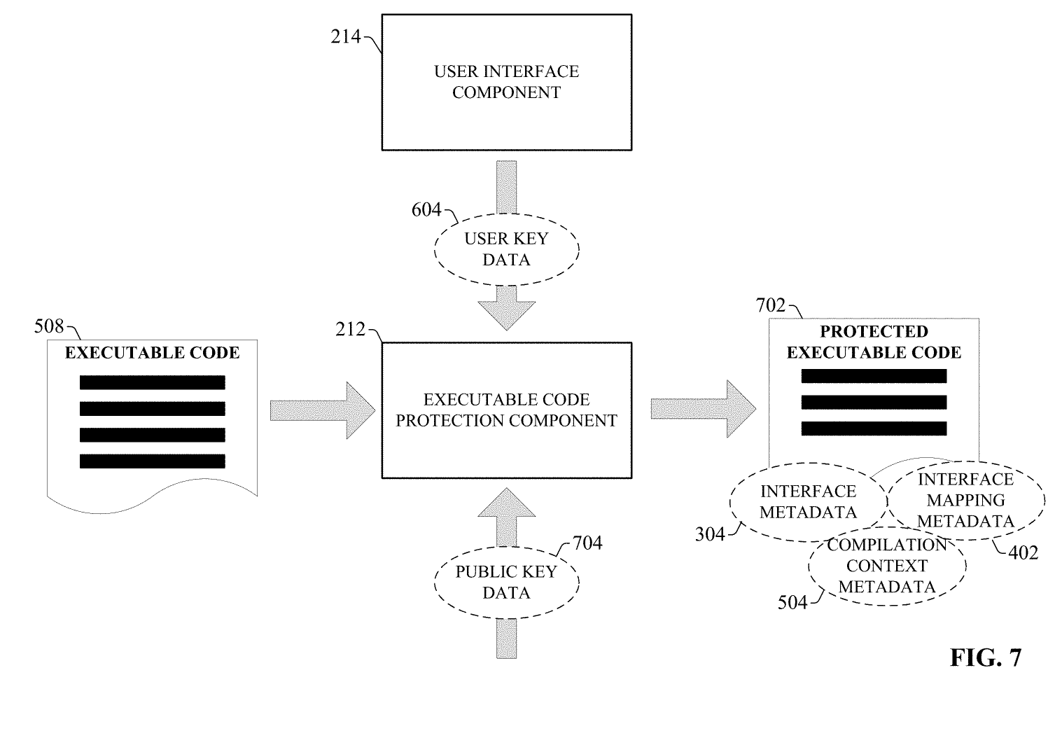

FIG. 7 is a block diagram illustrating generation of protected executable code 702 by the executable code protection component 212. Executable code protection component 212 can encrypt software IP in executable code form using a combination of user key data 604 derived from material that only authorized users and the target execution device possess and public key data 704 corresponding to a private key controlled by devices of the same type as the execution device. This combination provides protections for the executable code 508 in such a way that, after protection, the protected executable code 702 can only be accessed by the target execution device. This protection also allows for the ability to access and move the software IP between different devices of the same type as the target execution device (e.g., in the case of device failures).

As in the case of source code protection, user key data 604 can be provided to the executable code protection component 212 via user interface component 214. Public key data 704, which is based on the private key associated with the type of the target device, can be obtained by the executable code protection component 212 during compilation based on information collected from the execution platform for which the source code 302 is compiled. The executable code protection component 212 encrypts executable code 508 using user key data 604 and public key data 704 to yield protected executable code 702. By encrypting the executable code 508 using user key data 604, protected executable code 702 can only be decrypted into a plain text file if the correct user key data 604 is provided by the user. Moreover, encrypting the executable code 508 using public key data 704 ensures that the protected executable code 702 will only be allowed execute on target devices that possess the private key corresponding to the public key data 704. Since the private key is common to target devices of a similar type, the public key data 704 allows protected executable code 702 to be installed on replacement devices of the same type as the original target device in the event of a device failure, while preventing installation on possibly improper devices of a different type.

In some embodiments, system 202 can also bundle protected executable code 702 with the interface metadata 304, compilation context metadata 504, and interface mapping metadata 402 in order to provide the protections described above.

The protection of software IP is a concern for many developers and sellers of industrial software assets. The system and methods described herein can mitigate the possibility of a computer-based attack on digital rights management capabilities. The IP protection techniques described herein can provide a high level of protection while still affording the ability for authorized and non-authorized users to execute standard workflows on the software assets. In some embodiments, the precompile and encrypt system 202 can generate the interface metadata 304, interface mapping metadata 402, and compilation context metadata 504 in response to an initiation input provided by the user via the software development application on which the software is being developed (e.g., by clicking or touching a control graphic that initiates the protection process). The same initiation input can initiate the encryption of the source code 302 and/or the executable code 508, and the bundling of the metadata with the encrypted code. In this way, the system 202 supports a one-touch process that produces a deliverable software package (comprising source code or executable code bundled with metadata) that can be deployed to end users. The protected software package is protected from illicit copying or reproduction by virtue of the constraints defined by the metadata as well as the encryption, while still allowing the user a reasonable degree of freedom to manage or modify the software within the defined constraints (e.g., to accommodate modifications to other industrial applications with which the protected software communicates, or installation of the software on replacement devices in the event of a device failure).

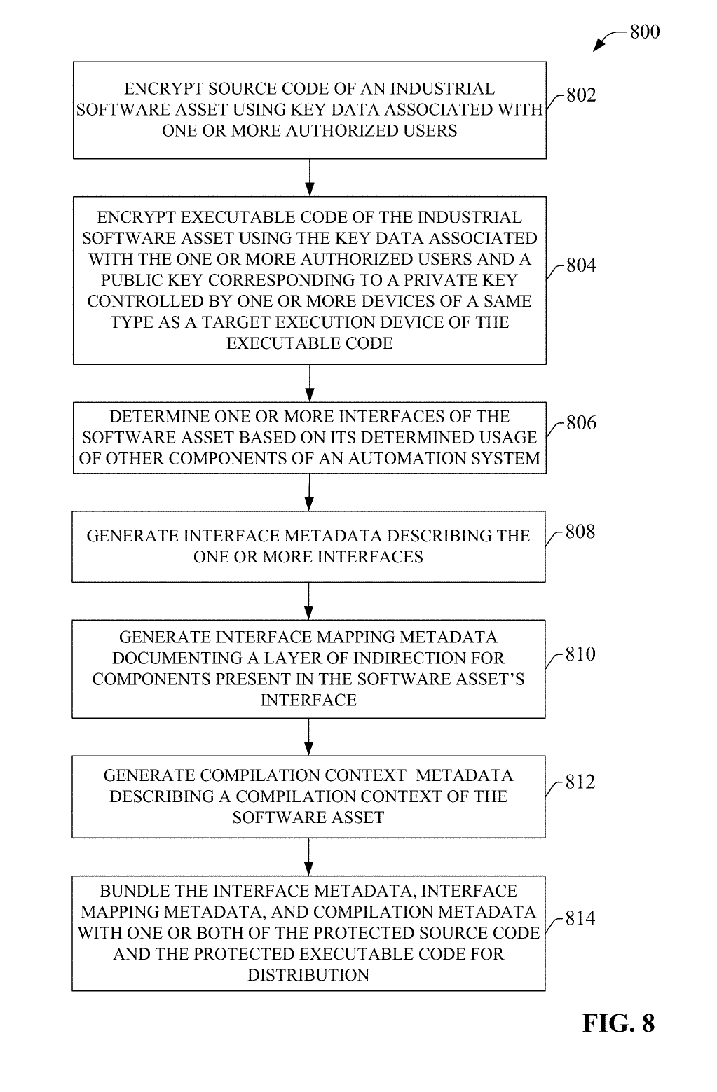

FIG. 8 illustrates a methodology in accordance with one or more embodiments of the subject application. While, for purposes of simplicity of explanation, the methodology shown herein is shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 8 illustrates an example methodology 800 for protecting an industrial software or digital asset. Initially, at 802, source code of an industrial software asset is encrypted using key data provided by one or more authorized users. The key data may include, but are not limited to, passphrases, biometric data, hardware tokens, or other such keys. At 804, executable code of the industrial software asset is encrypted using the key data associated with the one or more authorized users and a public key corresponding to a private key controlled by one or more devices of a same type as a target execution device of the executable code.

At 806, one or more interfaces of the software asset are determined based on the asset's determined usage of or reference to other components of an automation system. These other components can include, but are not limited to, data tags of other devices or software applications (e.g., data tags of control programs or HMI applications), modules, data types, instructions. At 808, interface metadata describing the one or more interfaces determined at step 806 is generated. The interface metadata can document the identified interfaces and relevant information about each of the interfaces, including the defined name of the interface (e.g., a data tag name), the data type associated with the interface, an identity of a remote data consumer or producer associated with the interface, or other such information. The interface metadata can also define, for each interface, one or more constraints that are to restrict how the interface can be edited by an end user. These constraints may restrict, for example, modifications of the interface's data type, name, external data consuming element (e.g., data tag or register) mapped to the interface, external data producing element mapped to the interface, or other properties of the interface. The determinations of which interface properties are to be restricted can be based on an analysis of the source code; e.g., a determination of how each interface is used in the source code.

At 810, mapping interface metadata documenting a layer of indirection for components present in the software asset's interface is generated. This layer of indirection acts as a layer of abstraction between the source code and the interface definition by associating each interface with an internal name that remains consistent even if the user modifies the interface name

At 812, compilation context metadata describing a compilation context of the software asset is generated. The compilation context metadata documents a required hardware-specific or firmware-specific execution context for proper execution of the software asset. The requisite compilation context can be determined based on one or both of an analysis of the source code (e.g., identification of references within the source code to device-specific libraries or tools) and an analysis of the hardware or computing context of the target device for which the source code is being compiled into executable code.

At 814, the interface metadata generated at step 808, the interface mapping metadata generated at step 810, and the compilation context metadata generated at step 812 are bundled with one or both of the protected source code of step 802 and the protected executable code of step 804 for distribution to end users.

It is to be appreciated that some steps of methodology 800 can be omitted in some embodiments, such that only one type of metadata, or a subset of the possible types of metadata, are generated and bundled with the source code or the executable code. For example, in some embodiments may only generate one or two of the interface metadata, the interface mapping metadata or the complication context metadata, and bundle the selected metadata types with the protected source code or the protected executable code for distribution.

Embodiments, systems, and components described herein, as well as industrial control systems and industrial automation environments in which various aspects set forth in the subject specification can be carried out, can include computer or network components such as servers, clients, programmable logic controllers (PLCs), automation controllers, communications modules, mobile computers, wireless components, control components and so forth which are capable of interacting across a network. Computers and servers include one or more processors—electronic integrated circuits that perform logic operations employing electric signals—configured to execute instructions stored in media such as random access memory (RAM), read only memory (ROM), a hard drives, as well as removable memory devices, which can include memory sticks, memory cards, flash drives, external hard drives, and so on.

Similarly, the term PLC or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, instrumentation, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, and Ethernet/IP. Other networks include Ethernet, DH/DH+, Remote I/O, Fieldbus, Modbus, Profibus, CAN, wireless networks, serial protocols, near field communication (NFC), Bluetooth, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

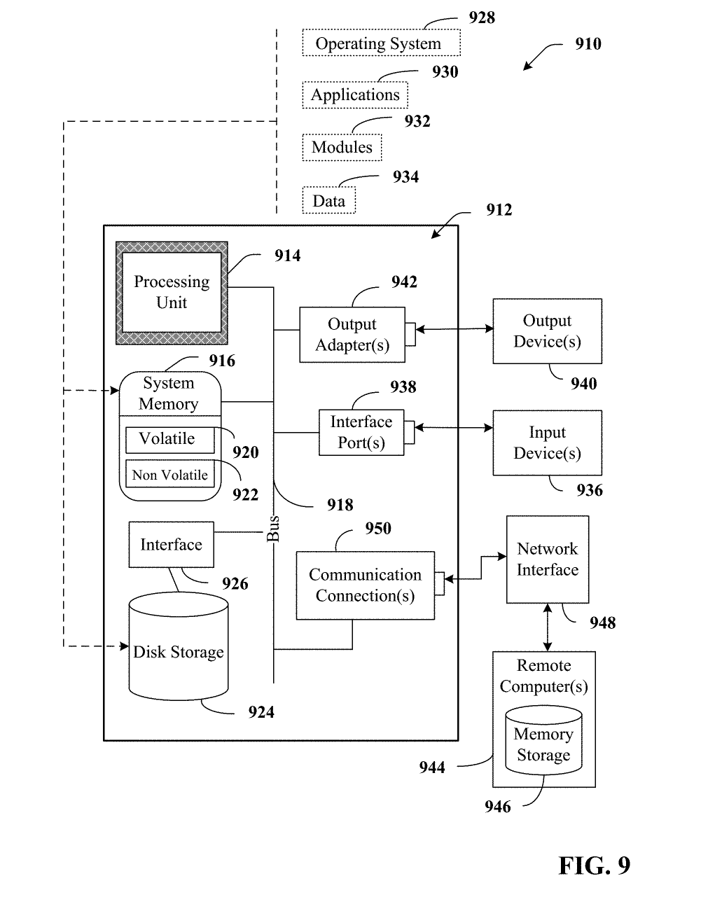

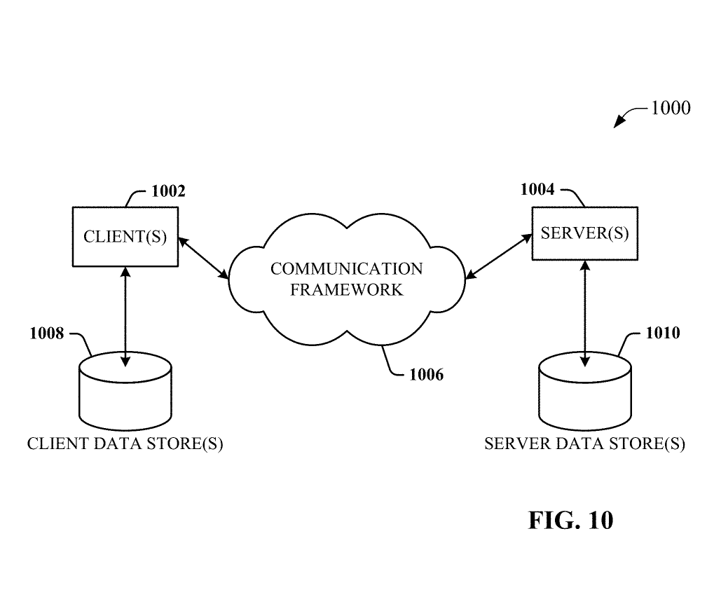

In order to provide a context for the various aspects of the disclosed subject matter, FIGS. 9 and 10 as well as the following discussion are intended to provide a brief, general description of a suitable environment in which the various aspects of the disclosed subject matter may be implemented.

With reference to FIG. 9, an example environment 910 for implementing various aspects of the aforementioned subject matter includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Multi-core microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable PROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer 912. System applications 930 take advantage of the management of resources by operating system 928 through program modules 932 and program data 934 stored either in system memory 916 or on disk storage 924. It is to be appreciated that one or more embodiments of the subject disclosure can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapters 942 are provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL). Network interface 948 can also encompass near field communication (NFC) or Bluetooth communication.

Communication connection(s) 950 refers to the hardware/software employed to connect the network interface 948 to the system bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample computing environment 1000 with which the disclosed subject matter can interact. The sample computing environment 1000 includes one or more client(s) 1002. The client(s) 1002 can be hardware and/or software (e.g., threads, processes, computing devices). The sample computing environment 1000 also includes one or more server(s) 1004. The server(s) 1004 can also be hardware and/or software (e.g., threads, processes, computing devices). The servers 1004 can house threads to perform transformations by employing one or more embodiments as described herein, for example. One possible communication between a client 1002 and servers 1004 can be in the form of a data packet adapted to be transmitted between two or more computer processes. The sample computing environment 1000 includes a communication framework 1006 that can be employed to facilitate communications between the client(s) 1002 and the server(s) 1004. The client(s) 1002 are operably connected to one or more client data store(s) 1008 that can be employed to store information local to the client(s) 1002. Similarly, the server(s) 1004 are operably connected to one or more server data store(s) 1010 that can be employed to store information local to the servers 1004.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What is claimed is:

1. A system for protecting a digital industrial asset, comprising:
a memory that stores executable components;
a processor, operatively coupled to the memory, that executes the executable components, the executable components comprising:
an interface analysis component configured to determine one or more interfaces of the digital industrial asset based on a determination of one or more elements of an industrial system referenced by source code of the digital industrial asset, and to generate interface metadata describing the one or more interfaces; and
a source code protection component configured to encrypt the source code using key data associated with an authorized user to yield protected source code, and to generate a protected asset comprising the protected source code and the interface metadata.

2. The system of claim 1, wherein the key data comprises at least one of a passphrase, biometric data, or data obtained from a hardware token.

3. The system of claim 1, wherein the one or more elements of the industrial system comprise at least one of a data tag of the industrial system, a module of the industrial system, or an instruction of the industrial system.

4. The system of claim 1, wherein the interface analysis component is further configured to define, based on an analysis of the source code, one or more modification constraints for at least one interface of the interfaces, and to generate the interface metadata to document the one or more modification constraints.

5. The system of claim 4, wherein the one or more modification constraints comprise at least one of a constraint on alteration of a data type of the at least one interface, a constraint on alteration of a name of the at least one interface, or a constraint on alteration of a link to an external data consumer or data producer defined for the interface.

6. The system of claim 4, wherein the protected asset is configured to prevent a modification to the protected source code that violates the one or more modification constraints.

7. The system of claim 1, further comprising an interface mapping component configured to generate interface mapping metadata documenting a layer of indirection for the one or more interfaces of the digital industrial asset,
wherein the source code protection component is further configured to generate the protected asset to comprise the protected source code and the interface mapping metadata.

8. The system of claim 1, further comprising an executable code protection component configured to encrypt executable code of the digital industrial asset using the key data and a public key corresponding to a private key associated with one or more target devices to yield protected executable code.

9. The system of claim 8, further comprising a compilation context component configured to generate compilation context metadata defining an execution platform context required for execution of the executable code,
wherein the executable code protection component is further configured to generate another protected asset comprising the protected executable code and the compilation context metadata.

10. The system of claim 9, wherein the execution platform context defines at least one of a firmware version, a data library, or a software tool required for execution of the executable code.

11. The system of claim 9, wherein the other protected asset is configured to prevent installation of the protected executable code on a device that does not support the execution platform context.

12. A method for creating a deliverable industrial software asset, comprising:
determining, by a system comprising a processor, one or more interfaces of the industrial software asset, the interfaces comprising references, defined in source code of the industrial software asset, to one or more elements of an industrial system,
generating, by the system, interface metadata describing the one or more interfaces;
encrypting, by the system, the source code using key data associated with an authorized user to yield protected source code; and
generating, by the system, a protected asset comprising the protected source code and the interface metadata.

13. The method of claim 12, further comprising defining, by the system based on an analysis of the source code, one or more modification constraints for at least one interface of the interfaces,
wherein the generating the interface metadata comprises documenting the one or more modification constraints in the interface metadata.

14. The method of claim 13, wherein the defining the one or more modification constraints comprises defining at least one of a constraint on alteration of a data type of the at least one interface, a constraint on alteration of a name of the at least one interface, or a constraint on alteration of a link to an external data consumer or data producer defined for the interface.

15. The method of claim 12, further comprising generating, by the system, interface mapping metadata documenting a layer of indirection for the one or more interfaces of the digital industrial asset,
wherein the generating the protected asset comprises generating the protected asset to comprise the protected source code and the interface mapping metadata.

16. The method of claim 12, further comprising encrypting executable code of the industrial software asset using the key data and a public key corresponding to a private key associated with one or more target devices to yield protected executable code.

17. The method of claim 16, further comprising:
determining, by the system, an execution platform context required for execution of the executable code; and
generating, by the system, compilation context metadata defining the execution platform context.

18. The method of claim 17, further comprising generating another protected asset comprising the protected executable code and the compilation context metadata.

19. A non-transitory computer-readable medium having stored thereon instructions that, in response to execution, cause a system comprising a processor to perform operations, the operations comprising:
determining one or more interfaces of a digital industrial asset, the interfaces comprising references, defined in source code of the digital industrial asset, to one or more elements of an industrial system;
generating interface metadata describing the one or more interfaces;
encrypting the source code using key data associated with an authorized user to yield encrypted source code; and
generating a protected asset comprising the encrypted source code and the interface metadata.

20. The non-transitory computer-readable medium of claim 19, further comprising defining, based on an analysis of the source code, one or more modification constraints for at least one interface of the interfaces,
wherein the generating the interface metadata comprises documenting the one or more modification constraints in the interface metadata.
